(19) United States
(12) Patent Application Publication
(10) Pub. No.: US 2008/0028150 A1
(43) Pub. Date: Jan. 31, 2008

(54) Autonomic Mode Switching for L2 Cache Speculative Accesses Based on L1 Cache Hit Rate

(76) Inventor: Farnaz Toussi, Eagen, MN (US)

Correspondence Address: MARTIN & ASSOCIATES, LLC, P.O. BOX 548, CARTHAGE, MO, 64836-0548, US

(21) Appl. No.: 11/460,806

(22) Filed: Jul. 28, 2006

(51) Int. Cl. G06F 12/00

(52) U.S. Cl. 711/122

(57) ABSTRACT

A speculative access mechanism in a memory subsystem monitors hit rate of an L1 cache, and autonomically switches modes of speculative accesses to an L2 cache accordingly. If the L1 hit rate is less than a threshold, such as 50%, the speculative load mode for the L2 cache is set to load-cancel. If the L1 hit rate is greater than or equal to the threshold, the speculative load mode for the L2 cache is set to load-confirm. By autonomically adjusting the mode of speculative accesses to an L2 cache as the L1 hit rate changes, the performance of a computer system that uses speculative accesses to an L2 cache improves.

### BACKGROUND

1. Technical Field

This disclosure generally relates to memory subsystems, and more specifically relates to methods for accessing multi-level cache memory in memory subsystems.

2. Background Art

Processors in modern computer systems typically access multiple levels of cache memory. A level 1 (L1) cache is typically very fast and relatively small. A level 2 (L2) cache is not as fast as L1 cache, but is typically larger in size. Subsequent levels of cache (e.g., L3, L4) may also be provided. Cache memories speed the execution of a processor by making instructions and/or data readily available in the very fast L1 cache as often as possible, which reduces the overhead (and hence, performance penalty) of retrieving the data from a lower level of cache or from main memory.

With multiple levels of cache memory, various methods have been used to prefetch instructions or data into the different levels to improve performance. For example, speculative accesses to an L2 cache may be made while the L1 cache is being accessed. A speculative access is an access for an instruction or data that may or may not be needed. It is “speculative” because at the time the request is made to the L2 cache, it is not known for sure whether the instruction or data will truly be needed. For example, a speculative access for an instruction that is beyond a branch in the computer code may never be executed if a different branch is taken.

Speculative accesses to an L2 cache can be done in different known ways. One such way is referred to as Load-Confirm. In a Load-Confirm mode, a speculative access to an L2 cache is commenced by issuing a “load” command to the L2 cache. The L2 cache determines whether it contains the needed data (L2 cache hit), or whether it must go to a lower level to retrieve the data (L2 cache miss). If the L1 cache then determines the data really is needed, a “confirm” command is issued to the L2 cache. In response, the L2 cache delivers the requested data to the L1 cache. A benefit of the Load-Confirm mode for performing speculative accesses is that a speculative load command may be issued, followed by a confirm command only when the data is actually needed. If the data is not needed, no confirm command is issued, so the L2 cache does not deliver the data to the L1 cache.

Another way to perform speculative accesses to an L2 cache is referred to as Load-Cancel. In a Load-Cancel mode, a speculative access to an L2 cache is commenced by the L1 cache issuing a “load” command to the L2 cache, the same as in the Load-Confirm scenario. The L2 cache determines whether it contains the needed data (L2 cache hit), or whether it must go to a lower level to retrieve the data (L2 cache miss). The L2 cache delivers the data to the L1 cache unless the operation is cancelled by issuing a “cancel” command to the L2 cache. If no cancel command is received by the L2 cache, the L2 cache delivers the requested data to the L1 cache. If a cancel command is received by the L2 cache, either before the speculative request is issued by the L2 controller or after the L2 access is done and data is ready for delivery to L1, the L2 cache aborts either the operation of issuing the speculative request or of delivering the requested data to the L1 cache. A benefit of the load-cancel mode for performing speculative accesses is that no confirm command need be issued to retrieve the data when it is actually needed. Instead, a cancel command is issued when the data is not needed.

Some modern memory subsystems perform both load-confirm and load-cancel speculative accesses depending on the type of access being performed. For example, speculative accesses to local memory could use load-cancel, while speculative accesses to remote memory could use load-confirm. However, known systems do not autonomically switch between different modes of speculative access based on monitored run-time conditions.

The two different modes described above for performing speculative accesses to an L2 cache may have different performance implications that may vary at run-time. Thus, selection of a load-confirm scenario at all times in a computer system may result in good performance at one point in time, and worse performance at a different point in time. Without a way to autonomically vary how speculative accesses to an L2 cache are performed based on run-time conditions in a memory system, the computer and electronics industries will continue to suffer from memory systems that do not have the ability to self-adjust to provide the best possible performance.

### BRIEF SUMMARY

A speculative access mechanism in a memory subsystem monitors hit rate of an L1 cache, and autonomically switches modes of speculative accesses to an L2 cache accordingly. If the L1 hit rate is less than a threshold, such as 50%, the speculative load mode for the L2 cache is set to load-cancel. If the L1 hit rate is greater than or equal to the threshold, the speculative load mode for the L2 cache is set to load-confirm. By autonomically adjusting the mode of speculative accesses to an L2 cache as the L1 hit rate changes, the resource utilization and performance of a computer system that uses speculative accesses to an L2 cache improves.

The foregoing and other features and advantages will be apparent from the following more particular description, as illustrated in the accompanying drawings.

### BRIEF DESCRIPTION OF THE SEVERAL VIEWS OF THE DRAWING(S)

The disclosure will be described in conjunction with the appended drawings, where like designations denote like elements, and:

FIG. 1 is a block diagram of an apparatus that includes autonomic mode switching for L2 cache speculative accesses based on L1 cache hit rate;

FIG. 2 is a block diagram of a known apparatus that may include load-confirm and/or load-cancel modes for performing speculative accesses to an L2 cache;

FIG. 3 is a flow diagram of a prior art method for performing load-confirm speculative accesses to an L2 cache;

FIG. 4 is a flow diagram of a prior art method for performing load-cancel speculative accesses to an L2 cache;

FIG. 5 is a flow diagram of a method for enabling and disabling speculative accesses to an L2 cache depending on the L1 hit rate; and

FIG. 6 is a flow diagram of a method for autonomically adjusting the mode of speculative accesses to an L2 cache based on the L1 hit rate.

### DETAILED DESCRIPTION

A speculative access mechanism controls how speculative accesses to an L2 cache are performed when an L1 cache miss occurs. The speculative access mechanism monitors hit rate of the L1 cache, and autonomically adjusts the mode of performing speculative accesses to the L2 cache according to the hit rate of the L1 cache. By autonomically adjusting the mode of performing speculative accesses to an L2 cache, the resource utilization and performance of the memory subsystem improves.

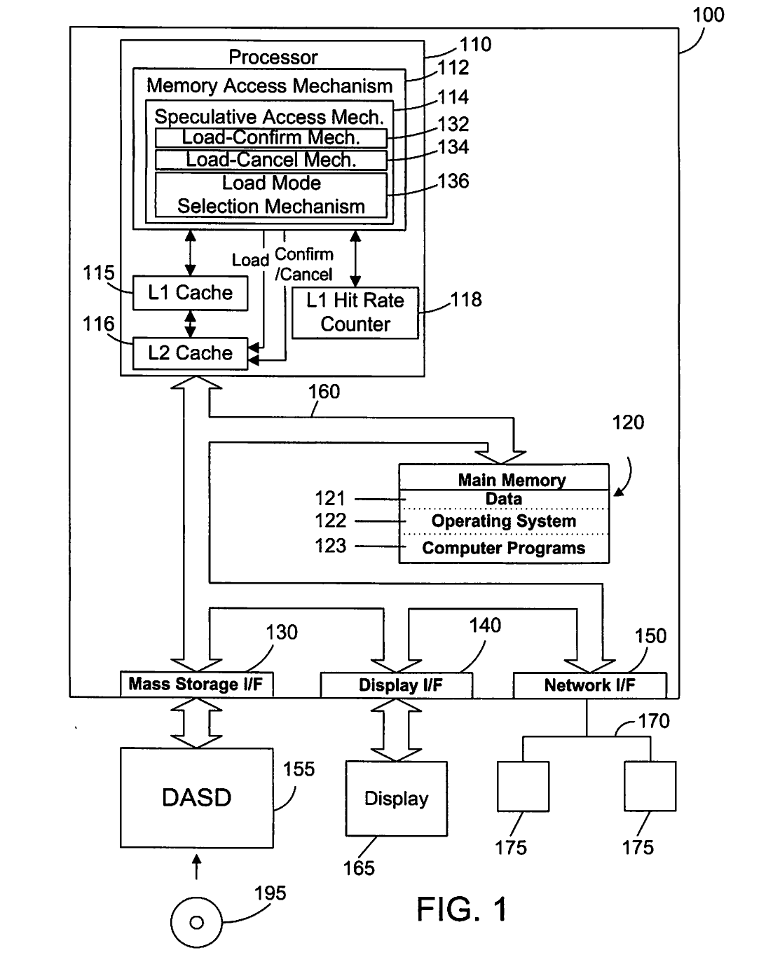

Referring to FIG. 1, a computer system 100 is one suitable implementation of an apparatus that performs autonomic adjustment of modes of L2 cache speculative accesses based on the hit rate of the L1 cache. Computer system 100 is an IBM eServer System i computer system. However, those skilled in the art will appreciate that the disclosure herein applies equally to any computer system, regardless of whether the computer system is a complicated multi-user computing apparatus, a single user workstation, or an embedded control system. As shown in FIG. 1, computer system 100 comprises one or more processors 110, a main memory 120, a mass storage interface 130, a display interface 140, and a network interface 150. These system components are interconnected through the use of a system bus 160. Mass storage interface 130 is used to connect mass storage devices, such as a direct access storage device 155, to computer system 100. One specific type of direct access storage device 155 is a readable and writable CD-RW drive, which may store data to and read data from a CD-RW 195.

Main memory 120 preferably contains data 121, an operating system 122, and one or more computer programs 123. Data 121 represents any data that serves as input to or output from any program in computer system 100. Operating system 122 is a multitasking operating system known in the industry as i5/OS; however, those skilled in the art will appreciate that the spirit and scope of this disclosure is not limited to any one operating system. Computer programs 123 may include system computer programs, utilities, application programs, or any other type of code that may be executed by processor 110.

Computer system 100 utilizes well known virtual addressing mechanisms that allow the programs of computer system 100 to behave as if they only have access to a large, single storage entity instead of access to multiple, smaller storage entities such as main memory 120 and DASD device 155. Therefore, while data 121, operating system 122, and computer programs 123 are shown to reside in main memory 120, those skilled in the art will recognize that these items are not necessarily all completely contained in main memory 120 at the same time. It should also be noted that the term “memory” is used herein generically to refer to the entire virtual memory of computer system 100, and may include the virtual memory of other computer systems coupled to computer system 100.

Processor 110 may be constructed from one or more microprocessors and/or integrated circuits. Processor 110 executes program instructions stored in main memory 120. Main memory 120 stores programs and data that processor 110 may access. When computer system 100 starts up, processor 110 initially executes the program instructions that make up operating system 122.

Processor 110 typically includes an L1 cache 115, and may optionally include an internal L2 cache 116. Note that the L2 cache 116 could be located external to processor 110. In addition, other levels of cache not shown in FIG. 1 could be interposed between the L2 cache and main memory 120. Processor 110 includes a memory access mechanism 112 that controls accesses to L1 cache 115, L2 cache 116, and main memory 120. The memory access mechanism 112 includes a speculative access mechanism 114 that governs how speculative accesses are performed to the L2 cache 116. The speculative access mechanism 114 includes a load-confirm mechanism 132, a load-cancel mechanism 134, and a load mode selection mechanism 136. The load mode selection mechanism 136 monitors the L1 hit rate by reading the L1 hit rate counter 118, and autonomically switches between the load-confirm mechanism 132 and the load-cancel mechanism 134 depending on L1 cache hit rate. By dynamically and autonomically switching between modes of speculative accesses of the L2 cache according to the hit rate of the L1 cache, the performance of the memory access mechanism 112 is improved when compared to prior art methods for performing speculative accesses to an L2 cache. While the figures and discussion herein recite switching between a load-confirm mode and a load-cancel mode, these are merely representative of first and second access mechanisms that use first and second modes, respectively, for performing speculative accesses to an L2 cache.

Although computer system 100 is shown to contain only a single processor and a single system bus, those skilled in the art will appreciate that autonomic switching of the access mode of speculative accesses may be practiced using a computer system that has multiple processors and/or multiple buses. In addition, the interfaces that are used preferably each include separate, fully programmed microprocessors that are used to off-load compute-intensive processing from processor 110. However, those skilled in the art will appreciate that the autonomic switching of the access mode of speculative accesses may be performed in computer systems that simply use I/O adapters to perform similar functions.

Display interface 140 is used to directly connect one or more displays 165 to computer system 100. These displays 165, which may be non-intelligent (i.e., dumb) terminals or fully programmable workstations, are used to allow system administrators and users to communicate with computer system 100. Note, however, that while display interface 140 is provided to support communication with one or more displays 165, computer system 100 does not necessarily require a display 165, because all needed interaction with users and other processes may occur via network interface 150.

Network interface 150 is used to connect other computer systems and/or workstations (e.g., 175 in FIG. 1) to computer system 100 across a network 170. Network interface 150 and network 170 broadly represent any suitable way to interconnect computer systems, regardless of whether the network 170 comprises present-day analog and/or digital techniques or via some networking mechanism of the future. In addition, many different network protocols can be used to implement a network. These protocols are specialized computer programs that allow computers to communicate across network 170. TCP/IP (Transmission Control Protocol/Internet Protocol) is an example of a suitable network protocol.

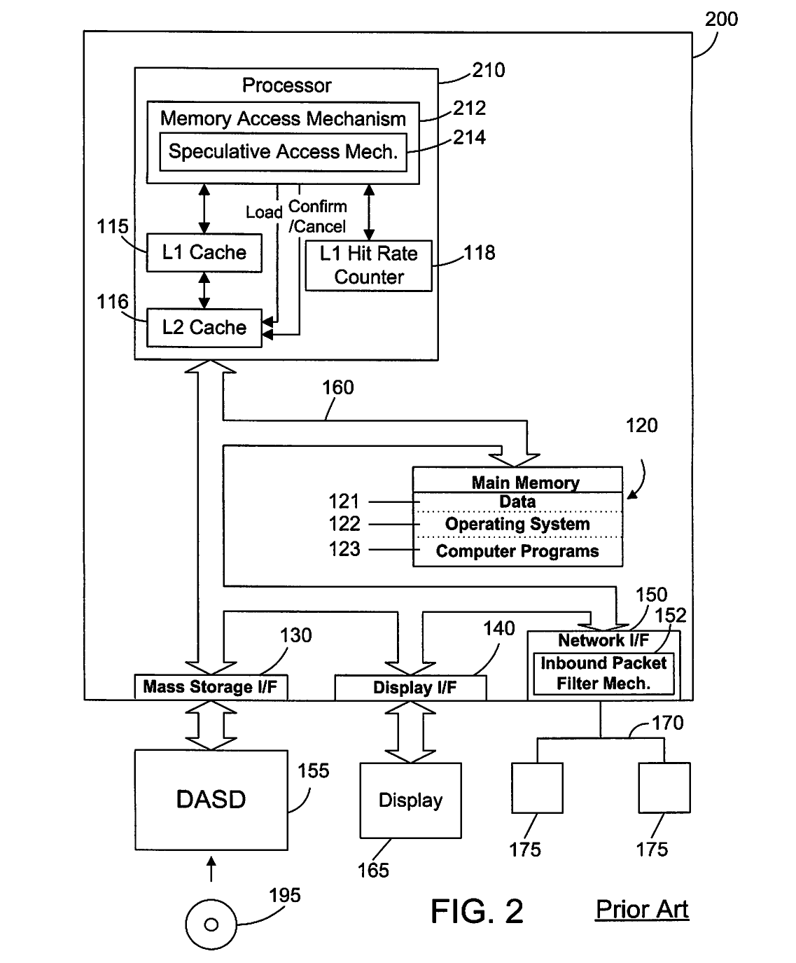

The prior art is now presented to illustrate differences between the prior art and the disclosure and claims herein. Referring to FIG. 2, a computer system 200 includes many of the same features as computer system 100 in FIG. 1 described in detail above, including main memory 120, data 121, operating system 122, computer programs 123, mass storage interface 130, display interface 140, network interface 150, direct access storage device 155, system bus 160, display 165, network 170, computer systems 175, and CD-RW 195. Computer system 200 also includes a processor 210 that includes an L1 cache 115, an L2 cache 116, and an L1 hit rate counter 118. The processor 210 additionally includes a memory access mechanism 212 that controls accesses to L1 cache 115, L2 cache 116 and main memory 120. Memory access mechanism 212 includes a speculative access mechanism 214 that controls speculative accesses to the L2 cache 116. In most prior art computer systems that include a speculative access mechanism 214, the speculative access mechanism 214 operates in a single mode of operation. As described above in the Background Art section, two different modes of operation are known in the art, namely load-confirm and load-cancel. Thus, the speculative access mechanism 214 may issue a load command to the L1 cache 115, and issue a speculative load command to the L2 cache 116. If the speculative access mechanism 214 uses load-confirm mode for speculative accesses, the L2 cache will not deliver the requested data to the L1 cache unless it receives a confirm command. If the speculative access mechanism 214 uses a load-cancel mode for speculative accesses, the L2 cache will deliver the requested data to the L1 cache unless it receives a cancel command. In most systems know in the art, the speculative access mechanism 214 operates in a single selected mode of operation, and does not use both load-confirm and load-cancel modes for speculative accesses.

One type of memory subsystem is known that is capable of using both load-confirm and load-cancel modes, depending on the type of access being performed. For example, speculative accesses to local memory could use load-cancel, while speculative accesses to remote memory could use load-confirm. However, known systems do not autonomically switch between different modes of speculative access based on L1 cache hit rate.

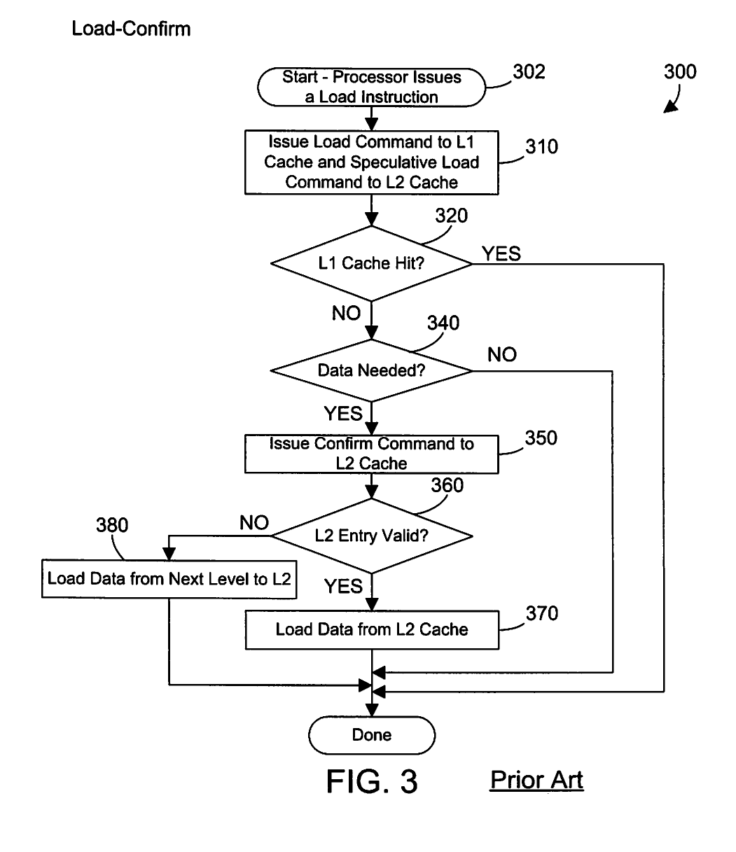

Referring to FIG. 3, a method 300 represents steps performed in a prior art load-confirm mode for speculative accesses to an L2 cache. Note that method 300 begins when a load instruction is issued by the processor (step 302). A non-speculative load command is issued to the L1 cache, and in parallel a speculative load command is issued to the L2 cache (step 310). If the non-speculative load causes a miss in the L1 cache (step 320=NO), the data from the L2 cache or from the next level is needed, where the next level denotes the next level down in the memory hierarchy (such as L3 cache or main memory). If the non-speculative load causes a hit in the L1 cache (step 320=YES), the data is already resident in the L1 cache so it need not be loaded from a lower level. If the data is needed (step 340=YES), a confirm command is issued to the L2 cache (step 350). In response the L2 cache assures its entry for the data is still valid and valid data is available for delivery to the L1 cache (step 360), and if so (step 360=YES), the data is loaded into the L1 cache from the L2 cache (step 370). If the L2 entry is not valid (step 360=NO), the data is loaded from the next level (step 380). Method 300 makes it clear that in cases when the data from the speculative access turns out not to be needed (step 340=NO), the processing required to load the data from the L2 cache is avoided.

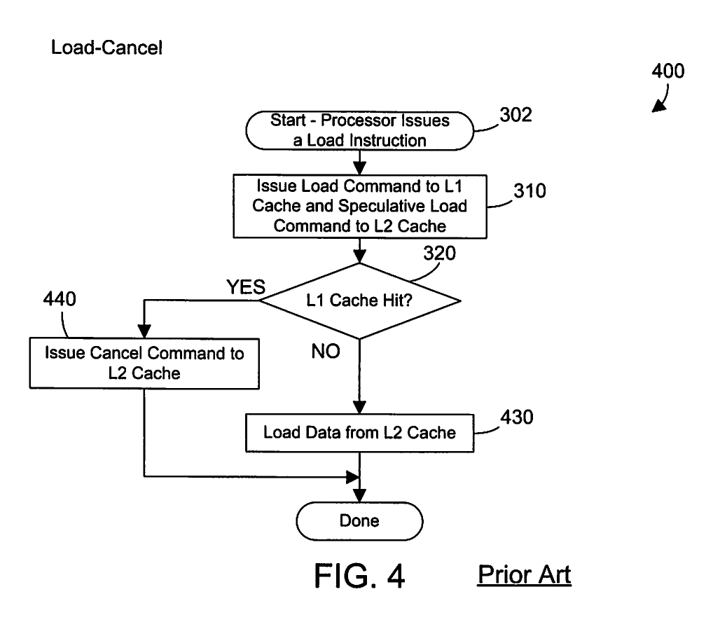

Referring to FIG. 4, a method 400 represents steps performed in a prior art load-cancel mode for speculative accesses to an L2 cache. Again, method 400 begins when the processor issues a load instruction (step 302). A non-speculative load command is issued to the L1 cache, and in parallel a speculative load command is issued to the L2 cache (step 310). If the non-speculative load causes a miss in the L1 cache (step 320=NO), the L1 cache waits for data to be loaded from the L2 cache (step 430). If the speculative load causes a hit in the L1 cache (step 320=YES), the data is already resident in the L1 cache so it need not be loaded from a lower level, so a cancel command is issued (step 440), and method 400 is done. Method 400 makes it clear that in cases when the data from the speculative access turns out to be needed (step 440=NO), the data may be loaded from the L2 cache without issuing an additional command.

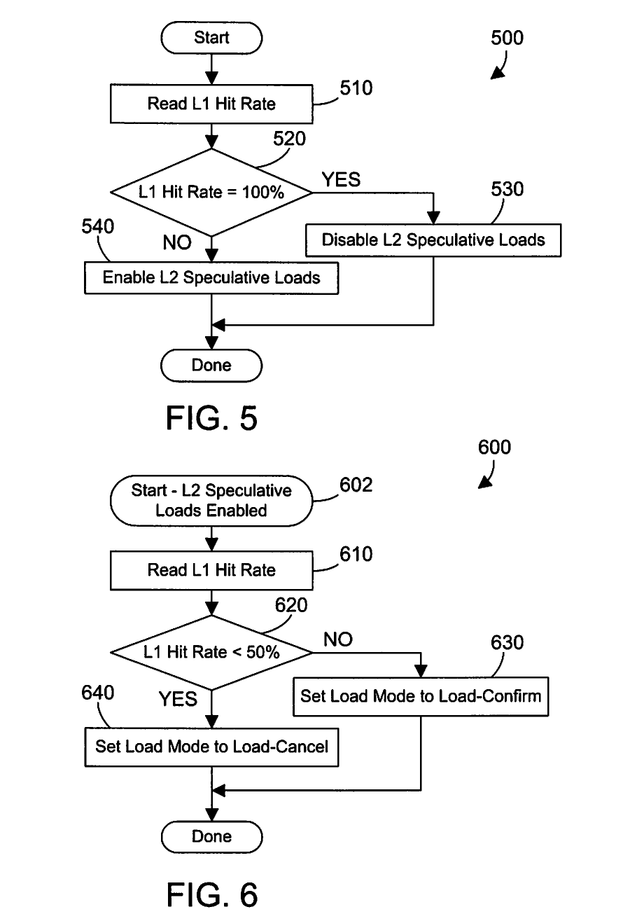

Referring to FIGS. 5 and 6, methods 500 and 600 show how the speculative access mechanism 114 in FIG. 1 can dynamically switch between different modes of performing speculative accesses of an L2 cache depending on the hit rate of the L1 cache as determined by reading the L1 hit rate counter 118. Referring to FIG. 5, the L1 hit rate is read (step 510). If the L1 hit rate is 100% (step 520=YES), speculative loads to the L2 cache are disabled (step 530) because they are not needed if the data is always available in the L1 cache. If the L1 hit rate is less than 100% (step 520=NO), L2 speculative loads are enabled (step 540). Note that during program execution the L1 hit rate varies and for some periods of time the working set may fit in the L1 cache and result in 100% L1 hit rate. Method 500 thus allows autonomically and dynamically enabling and disabling L2 speculative loads.

Method 600 shown in FIG. 6 is only performed when speculative loads are enabled (step 602). First, the L1 hit rate is read (step 610). If the L1 hit rate is greater than or equal to 50% (step 620=NO), the load mode is set to load-confirm (step 630). If the L1 hit rate is less than 50% (step 620=YES), the load mode is set to load-cancel (step 640). Method 600 thus allows autonomically and dynamically changing the mode of speculative accesses to L2 cache based on the hit rate of the L1 cache. Note that other thresholds could be used instead of the 50% shown in FIG. 6. Note also that two separate thresholds are shown in FIGS. 5 and 6, one to enable and disable speculative accesses as shown in FIG. 5, and another to switch modes of speculative accesses when speculative accesses are enabled, as shown in FIG. 6. The thresholds and logical operators are shown herein by way of example, and the disclosure and claims here apply regardless of the specific numerical values for the thresholds or the logical operators to determine when to enable/disable speculative accesses and when to switch modes of speculative accesses.

The performance benefit of method 600 may be understood by reviewing some examples. If load-confirm is used for speculative accesses to the L2 cache when the L1 cache hit rate is low, an excessive number of confirm commands to the L2 cache will have to be issued to retrieve the needed data. If load-cancel is used for speculative accesses to the L2 cache when the L1 cache hit rate is high, an excessive number of cancel commands to the L2 cache will have to be issued. By autonomically adjusting the mode of speculative accesses to an L2 cache based on L1 cache hit rate, the most optimal mode may be selected so the number of unneeded commands to the L2 cache is minimized.

One skilled in the art will appreciate that many variations are possible within the scope of the claims. Thus, while the disclosure is particularly shown and described above, it will be understood by those skilled in the art that these and other changes in form and details may be made therein without departing from the spirit and scope of the claims. For example, while the disclosure above refers to autonomically changing the access mode for speculative accesses to an L2 cache based on hit rate of an L1 cache, the same principles may be applied to any level of cache, where the access mode for speculative accesses to an LN cache may be autonomically changed based on the hit rate of the L(N-1) cache.

What is claimed is:

1. An apparatus comprising:
a cache at an Nth level (LN);
a cache at an (N-1)th level (L(N-1)); and
a memory access mechanism that controls accesses to the L(N-1) cache and to the LN cache, the memory access mechanism comprising a speculative access mechanism that controls speculative accesses to the LN cache, the speculative access mechanism comprising a first access mechanism, a second access mechanism, and a load mode selection mechanism that monitors hit rate of the L(N-1) cache and autonomically switches between the first access mechanism and the second access mechanism for speculative accesses to the LN cache based on hit rate of the L(N-1) cache.

2. The apparatus of claim 1 wherein the first access mechanism performs speculative accesses to the LN cache by issuing a load command to the LN cache for data followed by a confirm command to the LN cache when the data is needed.

3. The apparatus of claim 1 wherein the second access mechanism performs speculative accesses to the LN cache by issuing a load command to the LN cache for data followed by a cancel command to the LN cache when the data is not needed.

4. The apparatus of claim 1 wherein the load mode selection mechanism switches to the first access mechanism when the hit rate of the L(N-1) cache is above a selected threshold.

5. The apparatus of claim 4 wherein the load mode selection mechanism switches to the second access mechanism when the hit rate of the L(N-1) cache is below a selected threshold.

6. The apparatus of claim 5 wherein the selected threshold is 50%.

7. The apparatus of claim 1 wherein the speculative access mechanism is enabled when the hit rate of the L(N-1) cache is less than a selected threshold.

8. The apparatus of claim 7 wherein the selected threshold is 100%.

9. An apparatus comprising:
a first level (L1) cache;
a second level (L2) cache; and
a memory access mechanism that controls accesses to the L1 cache and to the L2 cache, the memory access mechanism comprising a speculative access mechanism that controls speculative accesses to the L2 cache when a hit rate of the L1 cache is less than a first threshold, the speculative access mechanism comprising a load-confirm access mechanism, a load-cancel access mechanism, and a load mode selection mechanism that monitors hit rate of the L1 cache selects the load-confirm access mechanism for speculative accesses to the L2 cache when the hit rate of the L1 cache is greater than or equal to a second threshold and selects the load-cancel access mechanism for speculative accesses to the L2 cache when the hit rate of the L1 cache is less than the second threshold.

10. The apparatus of claim 9 wherein the second threshold is 50%.

11. A method for performing speculative accesses to a cache at an Nth level (LN) in a memory subsystem that includes a cache at an (N-1)th level (L(N-1)), the method comprising the steps of:
monitoring hit rate of the L(N-1) cache; and
autonomically switching between a first access mode and a second access mode for speculative accesses to the LN cache based on the hit rate of the L(N-1) cache.

12. The method of claim 11 wherein the first access mechanism performs speculative accesses to the LN cache by issuing a load command to the LN cache for data followed by a confirm command to the LN cache when the data is needed.

13. The method of claim 11 wherein the second access mechanism performs speculative accesses to the LN cache by issuing a load command to the LN cache for data followed by a cancel command to the LN cache when the data is not needed.

14. The method of claim 11 wherein the load mode selection mechanism switches to the first access mechanism when the hit rate of the L(N-1) cache is above a selected threshold.

15. The method of claim 14 wherein the load mode selection mechanism switches to the second access mechanism when the hit rate of the L(N-1) cache is below a selected threshold.

16. The method of claim 15 wherein the selected threshold is 50%.

17. The method of claim 11 further comprising the step of enabling speculative accesses to the LN cache when the hit rate of the L(N-1) cache is less than a selected threshold and disabling speculative accesses to the LN cache when the hit rate of the L(N-1) cache is greater than or equal to the selected threshold.

18. The method of claim 17 wherein the selected threshold is 100%.
